(19) United States
(12) Patent Application Publication
(10) Pub. No.: US 2002/0188925 A1
(43) Pub. Date: Dec. 12, 2002

(54) Pattern-creating method, pattern-processing apparatus and exposure mask

(76) Inventor: Mizuho Higashi, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/117,091

(22) Filed: Apr. 8, 2002

(30) Foreign Application Priority Data
Apr. 11, 2001 (JP) P2001-112204

(51) Int. Cl. G06F 17/50

(52) U.S. Cl. 716/21; 716/19

(57) ABSTRACT

The present invention provides a pattern-creating method capable of optimizing formation of a transfer pattern with a high degree of precision and with ease. Performing a lithography process, the method includes the steps of determining a line-width-measurement location in a design pattern on the basis of a condition set in advance; adding a length-measurement-location recognition pattern at the determined location; classifying pattern portions composing the design pattern by degree of importance with which the shape of the design pattern is to be maintained; carrying out a simulation of transfer-pattern creation on the basis of the design pattern; measuring a line width of a transfer pattern at the location of the length-measurement-location recognition pattern; and evaluating a result of the simulation for each of the-degrees of importance, which are associated with the respective pattern portions composing the design pattern, and for each portions of the transfer pattern.

### BACKGROUND OF THE INVENTION

The present invention relates to a pattern-creating method, a pattern-processing apparatus and an exposure mask. More particularly, the present invention relates to a pattern-creating method, which is used for optimizing a process condition and a correction condition on the basis of a result of the simulation in a process to create a transfer pattern of a design pattern by carrying out lithography processing, relates to a pattern-processing apparatus adopting the pattern-creating method and relates to an exposure mask.

In a process to fabricate a semiconductor device, ion-injection and etching processes are carried out by using a resist pattern in a mask.

It is known that variations in dimension precision are generated in a resist pattern obtained as a result of a lithography process or a transfer pattern created by an etching process after the lithography process. Such variations are generated due to a variety of causes such as a process condition, a pattern layout density and an under-layer condition. In turn, the variations in dimension precision cause defects such as a short circuit between patterns and a breakage.

To solve this problem, simulation is carried out as a CAD (Computer Aided Design) tool at a process development stage. In the simulation, a variety of causes having effects on the shape of a transfer pattern are changed little by little. Then, while transfer patterns obtained as a result of the simulation are being studied, a process condition is optimized to give a transfer pattern close to a design pattern. In addition, in recent years, the so-called optical proximity correction is carried out to produce a transfer pattern closer to a design pattern. In this optical proximity correction, the pitch and the line width of an exposure pattern are corrected on the basis of a design pattern. Also in this optical proximity correction, simulation is carried out by using an exposure pattern obtained by correction of the design pattern little by little. The exposure pattern is then optimized by studying results of the simulation.

In the study of the simulation results, the error quantity of pattern edges between the design and transfer patterns as well as differences in line width between the design and transfer patterns are used as a study material. At that time, the error quantity is computed by carrying out graphical processing. On the other hand, differences in line width are found by manually measuring the line widths of the transfer pattern one after another by using a graphical user interfaces (GUI) and then subtracting the measured values from the design value of the design pattern.

With miniaturization of semiconductor devices in recent years, design patterns, particularly wiring patterns, have been becoming complicated. For this reason, it becomes extremely difficult to carry out the above optimization to satisfy requested uniform specifications for all parts of a design pattern. When the structure of a device becomes finer in the future, it is predictably impossible to implement the optimization for satisfying requested uniform specifications for all parts of a design pattern.

In addition, as described above, at the stage of studying results of simulation, a measurement of a pattern width (that is, length measurement) is carried out manually by using the GUI, hence requiring very much labor. As a matter of fact, the length measurement is carried out on parts selected from all length-measurement portions. Thus, it is mandatory to increase the number of length-measurement portions to carry out optimization with a high degree of precision.

### SUMMARY OF THE INVENTION

It is thus an object of the present invention to provide pattern-creating methods each allowing optimization of a process of forming a transfer pattern to be carried out with ease, a transfer-pattern-formation-optimizing method capable of maintaining a function of a transfer pattern and avoiding a defect with a high degree of reliability even in a semiconductor device of further advanced miniaturization, a processing apparatus for adopting the pattern-creating method and the transfer-pattern-formation-optimizing method and an exposure mask.

The pattern-creating methods provided by the present invention to achieve the object described above are each a pattern-creating method for creating a transfer pattern of a design pattern by carrying out a lithography process.

According to the first aspect of the present invention, there is provided a pattern-creating method for creating a transfer pattern of a design pattern by carrying out a lithography process including:

a first step of identifying line-width-measurement locations in a design pattern on the basis of a condition determined in advance, and adding a length-measurement-location recognition pattern at each of the line-width-measurement locations;

a second step of carrying out simulation of transfer-pattern creation on the basis of the design pattern;

a third step of measuring a line width of a transfer pattern obtained from the simulation at the position of each of the length-measurement-location recognition patterns; and

a fourth step of evaluating a result of the simulation on the basis of line widths of transfer patterns measured in the third step.

According to the second aspect of the present invention, there is provided a pattern-creating method for creating a transfer pattern of a design pattern by carrying out a lithography process including:

a first step of classifying pattern portions composing the design pattern by degree of importance with which the shape of the design pattern is to be maintained;

a second step of carrying out simulation of transfer-pattern creation on the basis of the design pattern; and

a third step of evaluating a result of the simulation for each of the degrees of importance, which are associated with the respective pattern portions composing the design pattern, and for each portion of the transfer pattern.

According to the third aspect of the present invention, there is provided a pattern-processing apparatus used in creation of a transfer pattern of a design pattern by carrying out a lithography process including:

a length-measurement-location-adding unit for identifying line-width-measurement locations in a design pattern on the basis of a condition determined in advance, and adding a length-measurement-location recognition pattern at each of the line-width-measurement locations;

a simulation unit for carrying out simulation of transfer-pattern creation on the basis of the design pattern;

a line-width-measuring unit for measuring a line width of a transfer pattern obtained from the simulation carried out by the simulation unit at the position of each of the length-measurement-location recognition patterns; and

an evaluation unit for evaluating a result of the simulation on the basis of line widths of transfer patterns measured by the line-width-measuring unit.

According to the fourth aspect of the present invention, there is provided a pattern-processing apparatus for creating a transfer pattern of a design pattern by carrying out a lithography process including:

a weight-classifying unit for classifying pattern portions composing the design pattern by degree of importance with which the shape of the design pattern is to be maintained;

a simulation unit for carrying out simulation of transfer-pattern creation on the basis of the design pattern; and

an evaluation unit for evaluating a result of the simulation for each of the degrees of importance, which are associated by the weight-classifying unit with the respective pattern portions composing the design pattern, and for each portion of the transfer pattern obtained from the simulation carried out by the simulation unit.

According to the fifth aspect of the present invention, there is provided an exposure mask used in creation of a transfer pattern of a design pattern by carrying out a lithography process, wherein each exposure pattern portion corresponding to one of parts composing the design pattern provides a peculiar shape margin to a degree of importance with which the shape of the design pattern is to be maintained.

As described above, the pattern-creating method according to the present invention and the processing apparatus adopting the pattern-creating method, a length-measurement-location recognition pattern is added to a design pattern on the basis of a condition set in advance. Consequently, a line width serving as an evaluation value of simulation can be automatically measured on the basis of position information of the length-measurement-location recognition pattern. As a result, the amount of labor required for the measurement of line widths can be reduced considerably. Thus, it is possible to evaluate a simulation result obtained from measurements of line widths at a greater number of locations and hence to identify a high-precision optimum parameter for creating a pattern.

Further, the pattern-creating method according to the present invention and the processing apparatus adopting the pattern-creating method, a simulation result is evaluated by classifying pattern portions composing a design pattern in advance for each degree of importance with which the shape of the design pattern is to be maintained. Consequently, the pattern portions can be evaluated by an evaluation standard proper for the degree of importance. As a result, a result of the simulation is evaluated so that specifications required individually for the pattern portions are satisfied while application of excessive specifications is being prevented and it is possible to identify an optimum parameter for pattern creation sustaining above-described function even for a miniaturized pattern.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a flowchart referred to in explanation of a pattern-creating method implemented by a first embodiment;

FIGS. 2A through 2D are explanatory diagrams each referred to in describing addition of a length-measurement-location recognition pattern in the first embodiment;

FIG. 3 is an explanatory diagram referred to in describing classification of pattern portions composing a design pattern by weight;

FIG. 4 is a diagram showing a model of simulation input data in the first embodiment;

FIGS. 5A through 5J are explanatory diagrams referred to in describing computation of a line width from a result of the simulation and describing classification by weight;

FIG. 6 is a diagram showing line-width-measurement results classified by weight;

FIGS. 7A through 7C are explanatory diagrams referred to in describing computation of an error quantity from a result of the simulation and describing classification by weight;

FIG. 8 is a diagram showing error quantity-computation results classified by weight;

FIG. 9 is a flowchart referred to in explanation of a pattern-creating method implemented by a second embodiment;

FIG. 10 is a diagram showing a model of data completing proximity correction in the second embodiment;

FIGS. 11A through 11C are explanatory histograms referred to in describing methods to evaluate results of simulation in the first and second embodiments;

FIG. 12 is a flowchart referred to in explanation of a pattern-creating method implemented by a third embodiment;

FIG. 13 is a diagram showing a design pattern to serve as a test pattern for creating a rule-based OPC correction table;

FIGS. 14A through 14C are explanatory diagrams referred to in describing addition of a length-measurement-location recognition pattern in the third embodiment; and

FIGS. 15A through 15F are explanatory diagrams referred to in describing computation of a line width from a result of the simulation.

### DETAILED DESCRIPTION OF THE PREFERRED EMBODIMENTS

Some preferred embodiments of the invention are explained in detail by referring to diagrams. It should be noted that, while the embodiments are each exemplified by a case in which a poly-silicon gate wire is created in a process to fabricate a semiconductor device, the scope of the present invention is not limited to such embodiments. Instead, the present invention can be widely applied to any pattern formation to create a transfer pattern by carrying out a lithography process.

[First Embodiment]

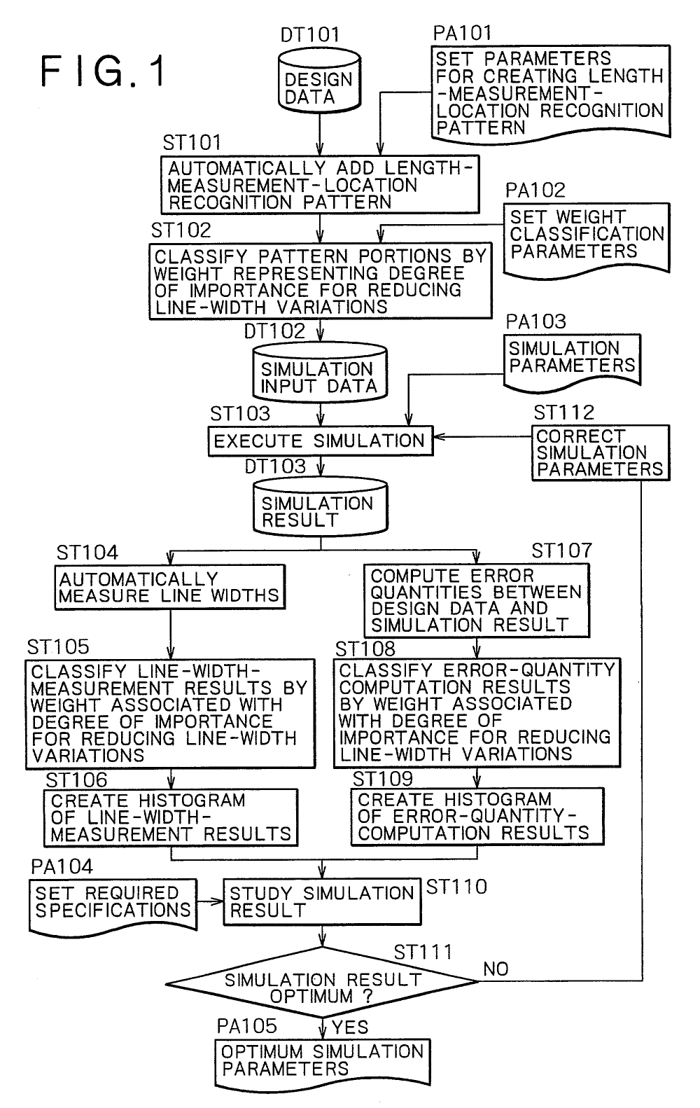

FIG. 1 is a flowchart referred to in explanation of a pattern-creating method implemented by a first embodiment of the present invention. By referring to this flowchart, the following description explains a procedure, which is used for optimizing a process condition when a gate wire is created as a transfer pattern. It should be noted that, in the following description, the elements in the flowchart each denoted by a notation in FIG. 1 are each explained by, if necessary, referring to other diagrams. The character DT in a notation denoting a flowchart element indicates that the flowchart element is data. The character ST in a notation denoting a flowchart element indicates that the flowchart element is processing. The character PA in a notation denoting a flowchart element indicates that the flowchart element is a set parameter.

DT101

First of all, design data for design patterns of a gate wire is input.

PA101

Meanwhile, a creation parameter is set for adding a length-measurement-location recognition pattern at a predetermined position of a design pattern represented by the design data DT101. The length-measurement-location recognition pattern is a pattern added to the design pattern to be used in recognition of a location in the design pattern. At the location, a line width to serve as an evaluation value for process optimization is to be measured. In this case, the location at which a length-measurement-location recognition pattern is to be added, that is, the location at which a line width is to be measured, and a method of adding the length-measurement-location recognition pattern are each set in advance as a parameter for creating the length-measurement-location recognition pattern.

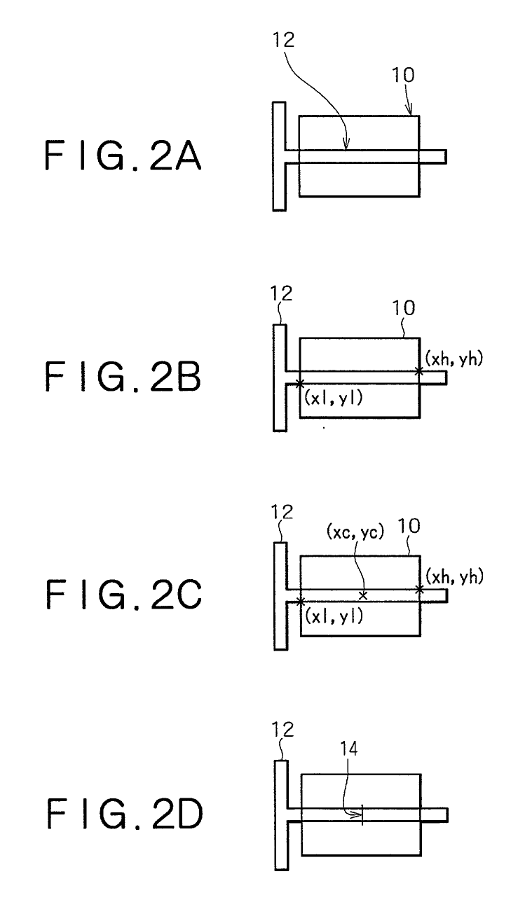

For example, as shown in FIG. 2A, the location at which a length-measurement-location recognition pattern is to be added and a method of adding the length-measurement-location recognition pattern are each set so that the length-measurement-location recognition pattern is always placed at a position at which a portion of a design pattern 12 of a gate wire (POLY) is located and an under-layer pattern 10 of an active diffusion layer (DIFF) on the substrate surface is intersected. In this case, first of all, coordinates (xl, yl) and (xh, yh) of an overlap portion of the under-layer pattern 10 and the design pattern 12 are acquired as shown in FIG. 2B. Then, the center coordinates (xc, yc) of the overlap position are acquired as shown in FIG. 2C. Subsequently, a parameter for creating the length-measurement-location recognition pattern 14 is set so that the length-measurement-location recognition pattern 14 is added to pass through these center coordinates (xc, yc) in a direction perpendicular to a longitudinal direction in which the design pattern 12 is extended as shown in FIG. 2D.

It should be noted that the above conditions are set so that the length-measurement-location recognition pattern 14 is added to not only the portion described above, but also to all locations at which a line width to be used as an evaluation value in optimization of a transfer pattern is to be measured.

PA102

In addition, a weight classification parameter is set for each of pattern portions composing a design pattern given by the design data DT101. The weight classification parameters are used for classifying the pattern portions composing the design pattern by degree of importance. The degree of importance by which the pattern portions are classified is a degree of importance with which the shape of the design pattern is to be maintained. The weight classification parameters each serving as a weight for the degree of importance are set in advance.

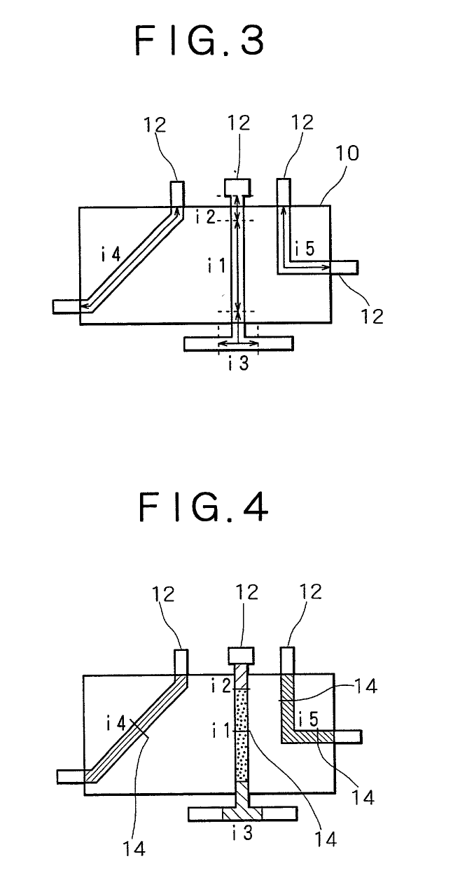

Take pattern portions composing the design pattern 12 placed on an under-layer pattern 10 shown in FIG. 3 as an example and let a weight be assigned to each of the pattern portions. In this case, weights i1, i2 and so on provide degrees of importance at a plurality of stages on the basis of the locations of the pattern portions composing the design pattern 12 on the under-layer pattern 10. Then, weight classification parameters are set so that the pattern portions of the design pattern 12, which are each indicated by an arrow in the figure, are classified into degrees of importance (or weights i1, i2 and so on) based on the locations of the pattern portions. As shown in the figure, the design pattern 12 includes three pattern portions, which are each a gate wire. Assume that the pattern portion serving as the center gate electrode must satisfy a most severe condition with respect to a shape discrepancy relative to the design pattern 12. In this case, the parameters are set so that the weight i1 having the highest degree of importance is assigned to this pattern portion.

ST101

After the operations to set the parameters PA101 and PA102 in advance as described above are completed, a length-measurement-location recognition pattern is automatically added to the design data DT101 representing the design pattern on the basis of the parameter PA101 for creation of the length-measurement-location recognition pattern.

ST102

Then, the pattern portions composing the design pattern represented by the design data DT101 are classified by degree of importance, and weights i1, i2 and so on are assigned on the basis of the weight classification parameter PA102.

DT102

As described above, the data of the length-measurement-location recognition pattern and the weight data are added to the design data DT101 to be used as simulation input data. FIG. 4 is a diagram showing a model of this simulation input data DT102. As shown in the figure, the simulation input data DT102 is data including the design data representing the design pattern 12 and the length-measurement-location recognition pattern 14 as well as the weight data, which are added to the design data. The weight data is classification weights i1, i2 and so on, which are each assigned to a pattern portion. It should be noted that, in FIG. 4, pattern portions classified by weights i1, i2 and so on are each represented by a hatched area to make explanation easy.

ST103

Next, simulation to create a transfer pattern is carried out on the basis of the simulation input data DT102. The simulation includes a lithography process and, if necessary, an etching process following the lithography process. To put it in detail, to create a resist pattern to serve as the transfer pattern, only simulation of the lithography process is carried out. To create a fabrication pattern to be used as the transfer pattern by carrying out an etching process using a resist pattern as a mask, on the other hand, the simulation includes a lithography process as well as an etching process following the lithography process. In this embodiment, the simulation includes the etching process. This is because optimization is applied to a case to create gate wires as a transfer pattern.

PA103

In the simulation ST103 described above, process conditions on the lithography process and the etching process are given as simulation parameters. These simulation parameters are used as initial values set in advance.

DT103

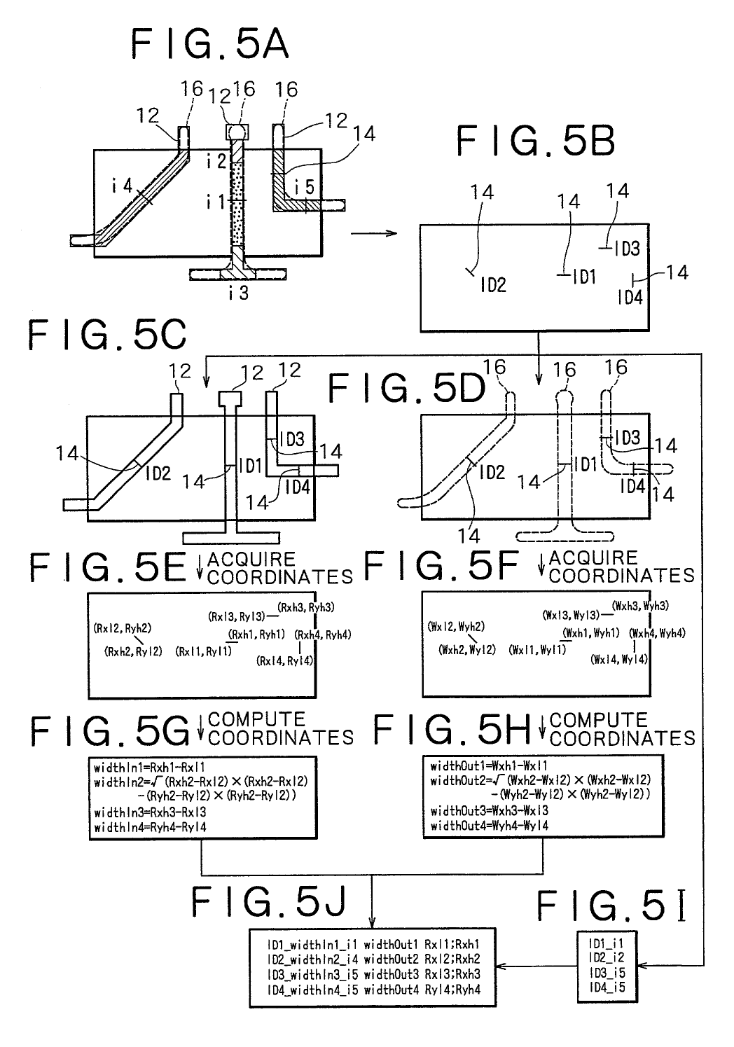

The simulation ST103 described above outputs data of the transfer pattern as a result of the simulation. FIG. 5A is a diagram showing transfer patterns 16 obtained as a result of the simulation ST103. The transfer patterns 16 are superposed on the design pattern, the length-measurement-location recognition patterns 14 added to the design patterns 12 and data of the weights i1, i2 and so on, which are assigned to the respective pattern portions of the design patterns 12. The transfer patterns 16 are created with shifts from the shapes of the design patterns 12.

ST104

After obtaining the simulation result DT103 described above, an automatic line-width measurement based on this simulation result DT103 is carried out. The automatic line-width measurement is an automatic measurement of line widths.

In this automatic line-with measurement, first of all, for all length-measurement-location recognition patterns 14, recognition symbols ID1, ID2 and so on are set as shown in FIG. 5B.

FIG. 5C is a diagram showing the length-measurement-location recognition patterns 14 and the design patterns 12 after setting of recognition symbols ID. Each length-measurement-location recognition pattern 14 intersects both-side edges of a design pattern 12. The coordinates of the intersection point are acquired as shown in FIG. 5E. Then, line widths widthIn1, widthIn2 and so on of the design patterns 12 at the locations of the length-measurement-location recognition patterns 14 are found from the coordinates as shown in FIG. 5G.

FIG. 5D is a diagram showing the length-measurement-location recognition patterns 14 and the transfer patterns 16 after setting of recognition symbols ID. Each length-measurement-location recognition pattern 14 intersects both-side edges of a transfer pattern 16. The coordinates of the intersection point are acquired as shown in FIG. 5F. Then, line widths widthOut1, widthOut2 and so on of the transfer patterns 16 at the locations of the length-measurement-location recognition patterns 14 are found from the coordinates as shown in FIG. 5H.

ST105

After the automatic line-width measurement ST104 described above is completed, the weights i1, i2 and so on of specific pattern portions are compared with the length-measurement-location recognition patterns. In the comparison, association of the recognition symbols ID with the weights i1, i2 and so on, which is shown in FIG. 5I, is referred to. In addition, results of the line-width measurement are classified by weights i1, i2 and so on associated with degrees of importance for reducing variations in line width.

As a result of the classification, the line widths widthIn1, widthIn2 and so on of the design pattern, the line widths widthOut1, widthOut2 and so on of the transfer pattern and the weights i1, i2 and so on are output while being associated with each other as shown in FIG. 5J. As described above, the weights i1, i2 and so on are assigned to pattern portions to which the length-measurement-location recognition patterns are added.

ST106

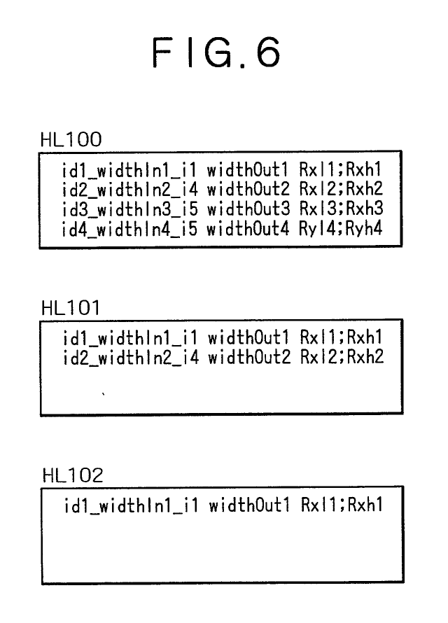

Next, to study the result of the simulation by using a statistical method in the subsequent processes, histograms of the line-width-measurement results obtained in the process described above are formed. Three histograms are created as shown in FIG. 6. The first histogram is a histogram of line-width-measurement results HL100 for all length-measurement locations. The second histogram is a histogram of line-width-measurement results HL101 excluding the location for the weight i5 having the lowest degree of importance. The third histogram is a histogram of line-width-measurement results HL102 excluding the locations for the two weights i4 and i5 having lowest degrees of importance.

ST107

Also after obtaining the simulation result DT103 described above, the error quantity of the simulation result relative to the design data is computed on the basis of the simulation result DT103. The error quantity is a discrepancy between the edge position of a design pattern indicated by the design data and the edge position of a transfer pattern obtained from the simulation.

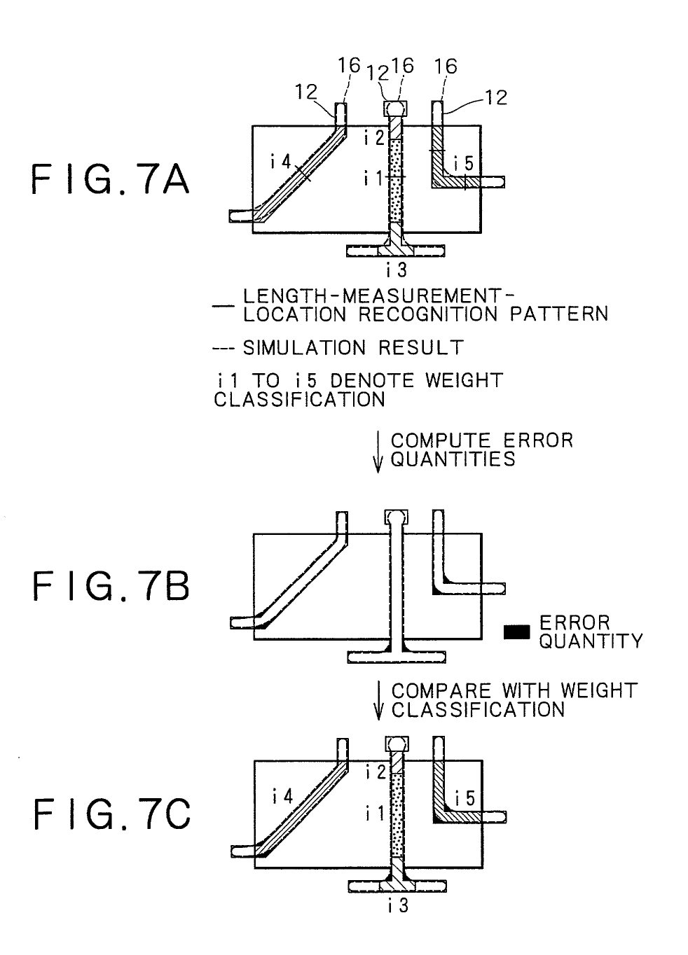

In the calculation of the error quantity, graphic processing is carried out on the design pattern 12 and the transfer pattern 16, which are shown in FIG. 7A. The calculated error quantities are painted areas shown in FIG. 7B.

ST108

After the error quantity calculation ST107 described above is completed, results of the error quantity computation are classified by weights i1, i2 and so on associated with degrees of importance for reducing variations in line width as shown in FIG. 7C.

ST109

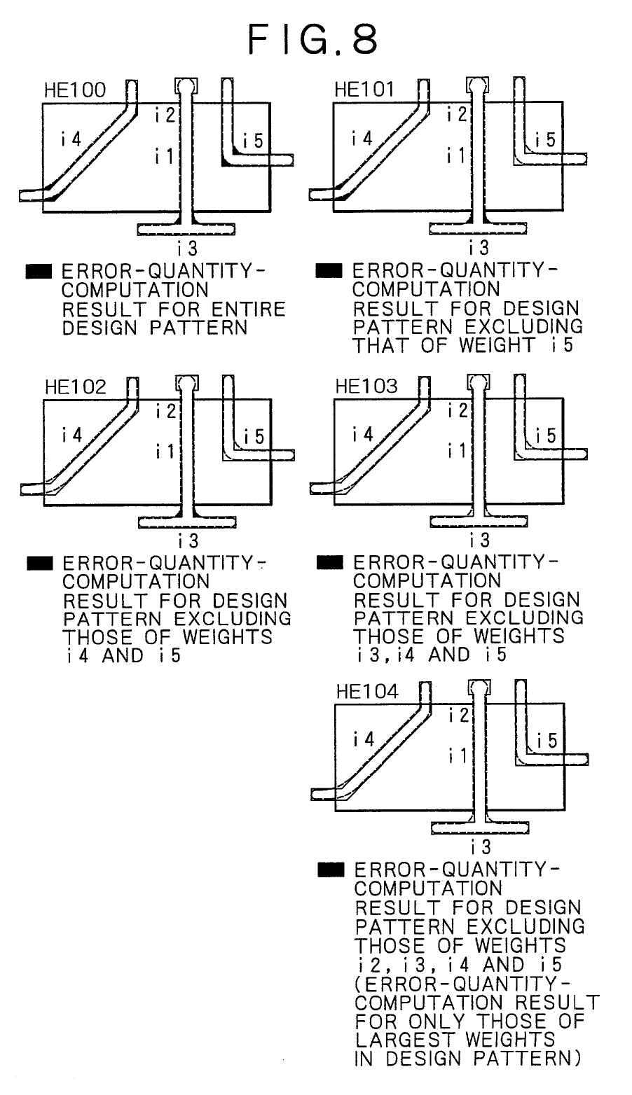

Next, to study the result of the simulation by using a statistical method in the subsequent processes, histograms of the results of the error quantity computation are formed. Five histograms are created as shown in FIG. 8. The first histogram is a histogram of error quantity-computation results HE100 including all weighted portions. The second histogram is a histogram of error quantity-computation results HE101 excluding the location for the weight i5 having the lowest degree of importance. The third histogram is a histogram of error quantity-computation results HE102 excluding the locations for the two weights i4 and i5 having the second lowest and the third lowest degrees of importance. The fourth histogram is a histogram of error quantity-computation results HE103 excluding the locations for the three weights i3, i4 and i5 having the second, the third and the fourth lowest degrees of importance. The fifth histogram is a histogram of error quantity-computation results HE104 excluding the locations for the four weights i2, i3, i4 and i5 having the second, the third, the fourth and the fifth lowest degrees of importance.

PA104

In addition, before studying the result of the simulation by using the histograms created as described above, required specifications to be used in the study of the simulation result are set in advance. The required specifications describe an allowable range of discrepancies of a transfer pattern relative to the shape of the design pattern. The required specifications also describe a shape margin for the design pattern. For example, in this case, the error quantity and a difference in line width (which is obtained from results of the line-width measurement) between the design pattern and the transfer pattern are used as two evaluation values. Then, with regard to these evaluation values, an allowable range (or required specifications) are set individually for each of the weights i1, i2 and so on. In this case, the higher the degree of importance, the stricter the required specifications.

ST110

Thereafter, a result of the simulation is studied. To put it in detail, the result of the simulation is studied by comparing the required specifications set individually for each of the weights assigned to their respective pattern portions with results of computation of evaluation values (that is, the difference in line width and the error quantity).

ST111

Then, a judgment is formed by carrying out statistical processing based on a created histogram. The formed judgment is a judgment as to whether or not the evaluation value is within its range prescribed in the required specifications set for each of the weights i1, i2 and so on.

Assume that the evaluation values are within their required specifications. In this case, the result of the simulation is determined to be final and the flow of the processing goes on in the YES direction. In addition, the initial simulation parameter PA103 for a case in which the simulation ST103 is executed is determined to be an optimum simulation parameter PA105, that is, an optimum process condition. The initial simulation parameter PA103 is taken as a process condition of an actual transfer-pattern creation process.

If the evaluation values are not within their required specifications, on the other hand, the result of the simulation is determined to be not final and the flow of the processing goes on in the NO direction.

ST112

If the flow of the processing goes on in the NO direction, the simulation parameter is corrected. To be more specific, the simulation parameter applied to the preceding simulation execution ST103 is corrected. The simulation parameter applied to the preceding simulation is the initial value PA103 of the simulation parameter.

ST103

After that, a second simulation is carried out by applying the corrected simulation parameter. Thereafter, the processing described above is carried out repeatedly until a YES determination result is obtained at the processing ST111 to indicate that the result of the simulation is final. The repeated processing results in the optimum simulation parameter PA105.

Then, the identified optimum simulation parameter is taken as an optimum process condition. Subsequently, an actual pattern (transfer pattern) based on design data is formed before terminating the creation of a series of patterns.

To create a pattern described above, a processing apparatus for executing processing represented by a flow shown in FIG. 1 is used. This processing apparatus includes a length-measurement-location-adding unit for carrying out the processing ST101, a weight-classifying unit for carrying out the processing ST102, a simulation unit for carrying out the processing ST103, a line-width-measuring unit for carrying out the processing ST104, an evaluation unit for carrying out the pieces of processing ST105 to ST111 and a parameter-correcting unit for carrying out the processing ST112.

In the first embodiment described above, a length-measurement-location recognition pattern is added in the processing ST101 to a design pattern on the basis of a parameter set in advance. Thus, line widths are automatically measured on the basis of position information of this length-measurement-location recognition pattern. The measured line widths are line widths at the same line-width measurement location on the design pattern and a transfer pattern obtained by simulation based on this design pattern. The amount of labor required for the measurement of line widths is therefore greatly reduced. Thus, in the evaluation of the simulation result, it is possible to conduct a study based on results of measurement at a greater number of line-width-measurement locations. As a result, by correcting the simulation parameter based on this result of the simulation, it is possible to identify an optimum simulation parameter (that is, an optimum process condition) having a higher degree of precision.

In addition, in the first embodiment, pattern portions composing a design pattern are classified by degree of importance with which the shape of the design pattern is maintained. A result of the simulation is then evaluated for each degree of importance. Thus, each pattern portion of the design pattern can be evaluated by an evaluation standard proper for the degree of importance of each pattern portion. Accordingly, the result of the simulation can be studied so that specifications required individually for the pattern portions can be satisfied while application of excessive specifications is being avoided. As a result, even in a process to fabricate a semiconductor device with advanced miniaturization, it is possible to obtain such an optimum process condition that the pattern portions fall within their respective specifications. In addition, if evaluation is carried out for each individual pattern portion, it becomes necessary to measure a line width in each pattern portion. In this embodiment, however, a line width can be measured automatically. Thus, such evaluation can be implemented. In addition, the shape margin with respect to the design pattern partially increases so that the process margin can also be increased as well.

[Second Embodiment]

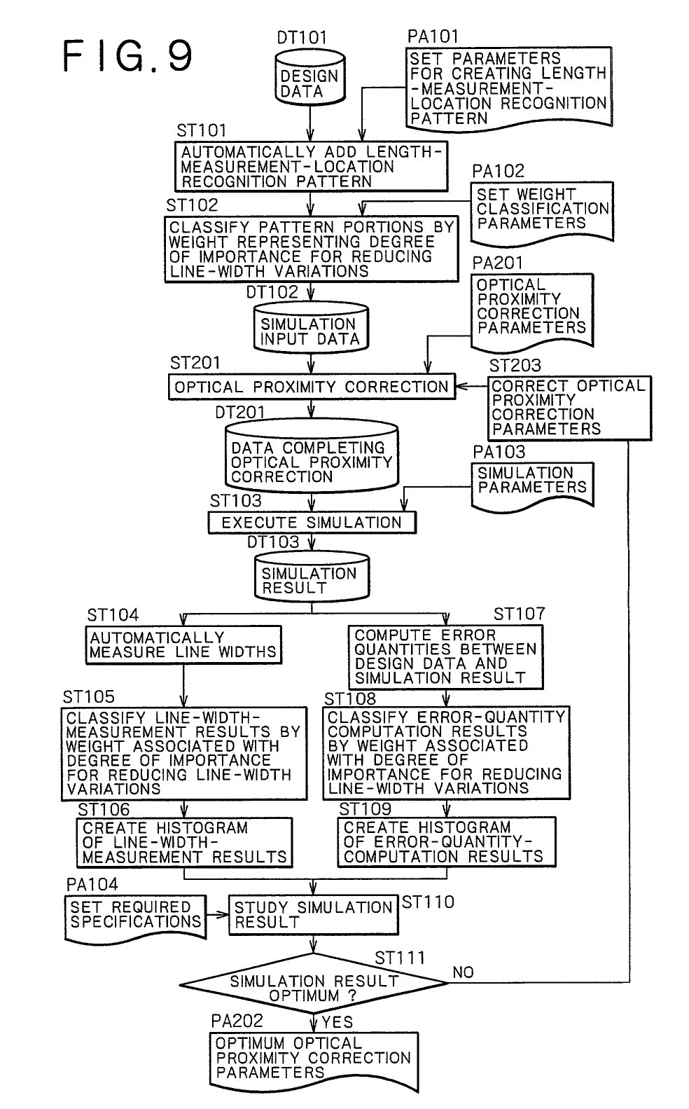

FIG. 9 is a flowchart used for explaining a second embodiment of the present invention. By referring to this flowchart, the following description explains a procedure, which is used for optimization when a gate wire is created as a transfer pattern. The optimization is carried out in a case in which an optical proximity correction is implemented for an exposure pattern used in pattern exposure in a lithography process. It should be noted that, in the following description, the flowchart's elements each denoted by a notation in FIG. 9 are each explained by, if necessary, referring to other diagrams. The character DT in a notation denoting a flowchart element indicates that the flowchart element is data. The character ST in a notation denoting a flowchart element indicates that the flowchart element is processing. The character PA in a notation denoting a flowchart element indicates that the flowchart element is a parameter. In addition, processing, data and a parameter, which are identical with those of the first embodiment, are denoted by the same notations as the latter, and their explanation is not repeated.

DT101, PA101 and ST101

Much like the first embodiment, design data DT101 for a design pattern of gate wires is obtained, a creation parameter PA101 for adding a length-measurement-location recognition pattern to this design data is set and, in processing ST101, the length-measurement-location recognition pattern is added to this design data representing the design pattern on the basis of this parameter.

PA102, ST102 and DT102

In addition, much like the first embodiment, a weight classification parameter PA102 is set for each pattern portion composing the design data DT101. The weight classification parameters are used for classifying the pattern portions composing the design pattern by degree of importance. For the design data DT101 representing the design pattern, the pattern portions are classified by weights i1, i2 and so on for each degree of importance in processing ST102 on the basis of the weight classification parameters PA102 to obtain simulation input data DT102.

ST201

This processing is processing peculiar to the second embodiment. To put it in detail, the design data DT101 included in the simulation input data DT102 is subjected to optical proximity correction to correct a design pattern represented by the design data DT101. This corrected design pattern (that is, the corrected pattern) is used as an exposure pattern created on an exposure mask.

PA201

A parameter used in this optical proximity correction ST201 is set in advance as a parameter set to be used in the optical proximity correction. This parameter to be used in the optical proximity correction is an initial value.

DT201

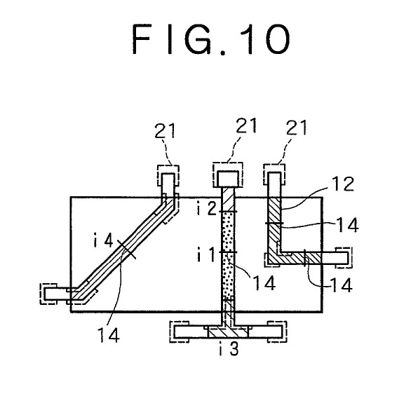

Then, data after the optical proximity correction is obtained from the optical proximity correction ST201 using the initial parameter PA201 for the optical proximity correction. FIG. 10 is a diagram showing a corrected pattern 21 superposed on the design pattern 12. The corrected pattern 21 is expressed by the data after the optical proximity correction. In addition, this figure also shows a length-measurement-location recognition pattern 14 and weights i1, i2 and so on. The length-measurement-location recognition pattern 14 is added to the design pattern 12 in the processing ST101. The weights i1, i2 and so on assigned to portions of the design pattern 12 are classified in the processing ST102.

PA103 and ST103

Next, simulation ST103 for creating a transfer pattern is carried out on the data DT201 after the optical proximity correction with an initial simulation parameter PA103 used as a process condition. The initial simulation parameter PA103 is set in advance.

DT103 and ST104 to ST109

The simulation ST103 described above produces data DT103 of a transfer pattern as a result of the simulation. Then, much like the first embodiment, an automatic line-width measurement ST104, classification ST105 of line-width-measurement results by weight and histogram creation ST106 of the line-width-measurement results are carried out. Also much like the first embodiment, an error quantity computation ST107, classification ST108 of error quantity-computation results by weight and histogram creation ST109 of the error quantity-computation results are carried out.

PA104, ST110 and ST111

Then, much like the first embodiment, an error quantity and a difference in line width between the design and transfer patterns are used as two evaluation values. With regard to these evaluation values, required specifications PA104 are set individually for each of the weights i1, i2 and so on. Subsequently, much like the first embodiment, a result of the simulation is studied in processing ST110 and, processing ST111 is carried out to form a judgment as to whether or not the result of the simulation is optimum.

If the result of the simulation is determined to be optimum, the flow of the processing goes on to the YES direction. Then, the optical proximity correction parameter PA201 applied to the optical proximity correction ST201 is determined to be an optimum optical proximity correction parameter PA202 used in correction of an exposure pattern of an exposure mask used in an actual transfer-pattern creation process. In actuality, as a process condition, an initial simulation parameter PA103 is used.

If the evaluation values are not within their respective required specifications, on the other hand, the result of the simulation is determined to be not optimum. In this case, the flow of the processing goes on to the NO direction.

ST203

If the flow of the processing goes on to the NO direction, the parameter for the optical proximity correction is corrected. To be more specific, the optical proximity correction parameter applied to the preceding optical proximity correction ST201, that is, the initial optical proximity correction parameter PA201, is corrected.

ST201

Thereafter, the design data DT101 included in the simulation input data DT102 is subjected to optical proximity correction ST201 by applying a corrected parameter for the optical proximity correction to correct the design pattern represented by the design data DT101.

Then, a second simulation ST103 is carried out on the basis of new data DT201 after the optical proximity correction. The new data DT201 is obtained as a result of the correction. Thereafter, the process described above is carried out repeatedly until the outcome of the judgment formed in the processing ST111 becomes YES indicating that the result of the simulation is optimum. When the outcome of the judgment formed in the processing ST111 becomes YES, a parameter PA202 for the optical proximity correction is identified.

Then, on the basis of the identified parameter PA202 for the optical proximity correction, optical proximity correction is carried out on the design pattern to create an exposure pattern of an exposure mask. Then, a lithography process using the obtained exposure mask is carried out to create an actual pattern (a transfer pattern) based on the design data.

The exposure mask obtained in this way is a mask wherein exposure-pattern portions corresponding to their respective portions composing the design pattern satisfy required specifications given individually for each degree of importance with which the shape of the design pattern is maintained. That is to say, the exposure mask is a mask wherein a peculiar shape margin is provided for each exposure-pattern portion.

To implement the pattern creation described above, a processing apparatus is used for carrying out processing represented by the flowchart shown in FIG. 9. The processing apparatus comprises an optical proximity correction unit for carrying out the new processing ST201 in addition to the units employed in the first embodiment. In addition, in the case of the second embodiment, the parameter-correcting unit employed in the first embodiment is replaced with a unit for correcting the parameter for the optical proximity correction ST203.

Much like the first embodiment, in the second embodiment explained above, a length-measurement-location recognition pattern is added to a design pattern in the processing ST101 on the basis of a parameter set in advance. Thus, in evaluation of a simulation result, it is possible to conduct a study based on length-measurement results obtained at a larger number of line-width-measurement locations.

In addition, much like the first embodiment, a result of the simulation is evaluated for each of degrees of importance assigned to pattern portions composing a design pattern. Thus, the result of the simulation can be studied so that specifications required individually for the pattern portions can be satisfied while application of excessive specifications is being avoided. As a result, it is possible to obtain an optimum optical proximity correction parameter that can be sufficiently implemented even in a process to fabricate a semiconductor device with advanced miniaturization.

Furthermore, in the case of the second embodiment, it is possible to apply the present invention to simulation for obtaining a parameter optimum for optical proximity correction. Thus, an exposure mask created by applying the optimum optical proximity correction parameter obtained in this way is such an exposure mask that portions of the exposure pattern satisfy required specifications provided individually for each degree of importance with which the shape of the design pattern is maintained.

It should be noted that, in the first and second embodiments described above, in the processing ST110 to study a result of the simulation, required specifications are set individually for each of the weights i1, i2 and so on, which each represent a degree of importance, and pattern portions are evaluated. However, the method adopted in the study of the simulation result is not limited to this technique of comparison with required specifications. It is also possible to adopt another technique whereby an optimum parameter is selected by evaluation through simulation for each of the weights i1, i2 and so on.

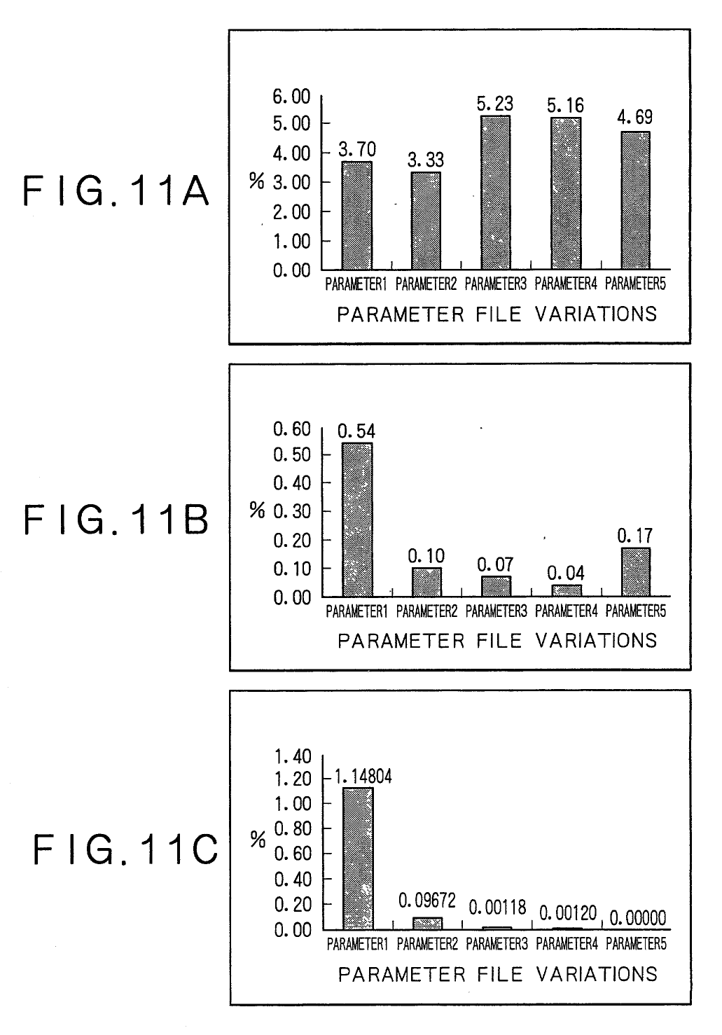

FIG. 11 is histograms showing error-generation rates of required specifications for a case in which parameters for optical proximity correction are set as parameters 1 to 5 and fixed required specifications are set for all the weights i1, i2 and so on. To be more specific, FIG. 11A shows error-generation rates for a case in which pattern portions for all the weights i1, i2 and so on are included.

In the case of this embodiment, however, pattern portions of the design pattern are classified by the weights i1, i2 and so on each associated with a degree of importance. From FIG. 11B, it is possible to obtain information on error-generation rates for a case in which pattern portions for all the weights i1, i2 and so on except the weights i4 and i5 for lowest degrees of importance are included. From FIG. 11C, it is possible to obtain information on error-generation rates for a case in which only the pattern portion for the weight i1 for the-highest degree of importance is included.

Thus, when it is desired to assure pattern shapes of pattern portions classified into the weights i1, i2 and i3 except the weights i4 and i5 for lowest degrees of importance, parameter 4 is selected from FIG. 11B as an optimum parameter. When it is desired to reliably assure pattern shapes of pattern portions classified into the weight i1 for the highest degree of importance, parameter 5 is selected from FIG. 11C as an optimum parameter.

[Third Embodiment]

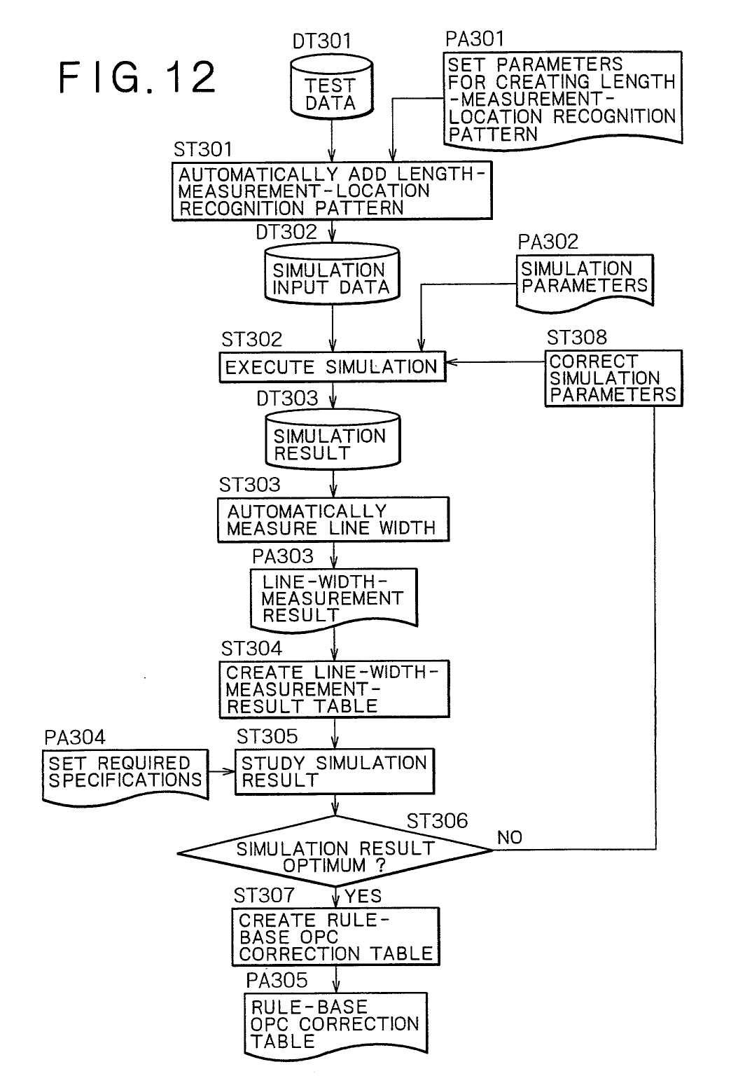

FIG. 12 is a flowchart used for explaining a third embodiment of the present invention. By referring to this flowchart, the following description explains a procedure of optimizing a correction table used when implementing a rule-based optical proximity correction (abbreviated hereafter to a rule-based OPC) for an exposure pattern used in pattern exposure in a lithography process for creation of gate wires as a transfer pattern. It should be noted that, in the following description, the flowchart's elements each denoted by a notation in FIG. 12 are each explained by, if necessary, referring to other diagrams. The character DT in a notation denoting a. flowchart element indicates that the flowchart element is data. The character ST in a notation denoting a flowchart element indicates that the flowchart element is processing. The character PA in a notation denoting a flowchart element indicates that the flowchart element is a parameter.

DT301

First of all, test data concerning a test pattern for creating a correction table is acquired. FIG. 13 is a diagram showing a design pattern represented by this test pattern. The design pattern is a design pattern for creating a correction table. This design pattern consists of a plurality of blocks. Each of the blocks consists of five line-like patterns 31, which each have a line width W and are arranged to form a set at a pitch P. The line width W and the pitch P vary from block to block. The blocks are separated from each other by a sufficient gap (yspace, xspace). The length L of the design pattern is fixed.

PA301

On the other hand, a creation parameter for adding a length-measurement-location recognition pattern is set at a predetermined location in the design pattern represented by test data DT301. The length-measurement-location recognition pattern is a pattern added to the design pattern. The length-measurement-location recognition pattern is used for recognizing a location in the design pattern. At the location, a line width is to be measured. The line width is an evaluation value in creation of a correction table to be used as a rule-based OPC table. The location at which the length-measurement-location recognition pattern is to be added and a method of adding the length-measurement-location recognition pattern are each set in advance as a condition. The location is a location at which a line width is to be measured.

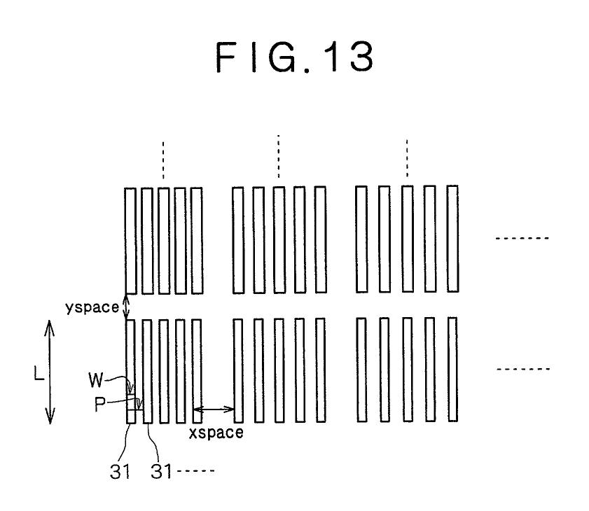

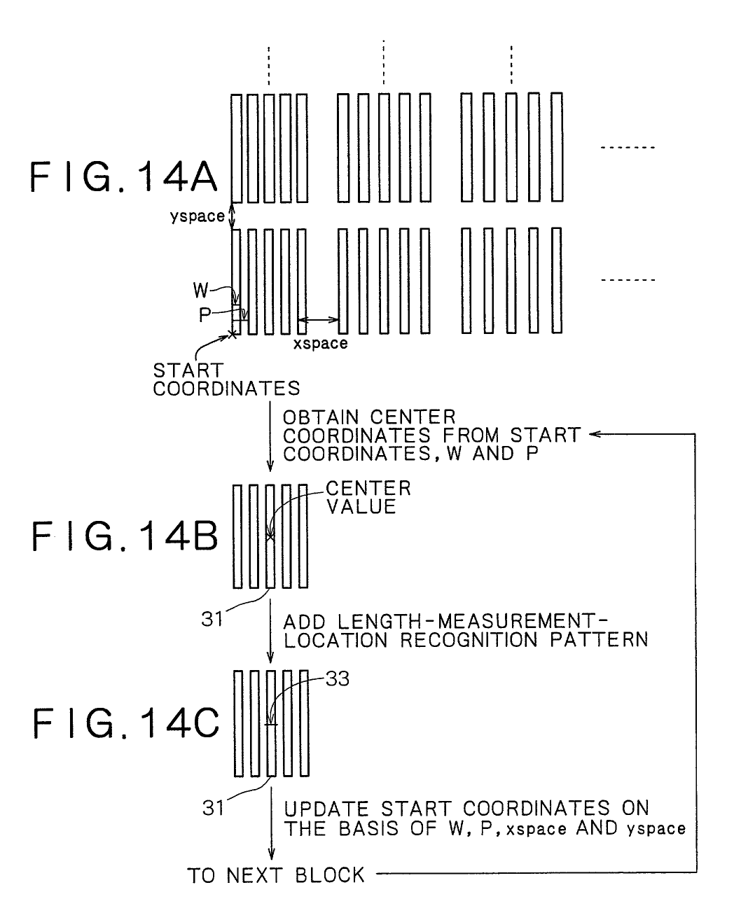

For example, the location at which the length-measurement-location recognition pattern is to be added is set as follows. The length-measurement-location recognition pattern is located at the center position of a line-like pattern placed at the center of each block. In this case, the blocks are laid out regularly as shown in FIG. 14A and the coordinates of the edge of a block at the end is taken as start coordinates. Then, the coordinates of the center position of a line-like pattern 31 placed at the center of each block are acquired as shown in FIG. 14B. This operation is carried out sequentially for each of the blocks. Finally, a parameter for creation of the length-measurement-location recognition pattern 33 is set so that the length-measurement-location recognition pattern 33 is added at the acquired center coordinates in a direction perpendicular to a longitudinal direction in which the line-like pattern 31 is extended as shown in FIG. 14C.

ST301

After the operation of setting the parameter PA301 in advance as described is completed, the length-measurement-location recognition pattern is automatically added to test data DT301 representing the design pattern on the basis of the parameter PA301, which is used for creation of the length-measurement-location recognition pattern.

DT302

Then, data comprising the test data DT301 and data of the length-measurement-location recognition pattern added to test data DT301 is used as simulation input data.

ST302

Subsequently, simulation of creation of a transfer pattern is carried out on the basis of the simulation input data DT302. The simulation includes a lithography process and, if necessary, an etching process following the lithography process. To put it in detail, to create a resist pattern to serve as the transfer pattern, only simulation of the lithography process is carried out. To create a fabrication pattern to be used as the transfer pattern by carrying out an etching process using a resist pattern as a mask, on the other hand, the simulation includes a lithography process as well as an etching process following the lithography process.

PA302

In the simulation ST302 described above, process conditions of the lithography and etching processes are given as simulation parameters. These simulation parameters are used as initial values set in advance.

DT303

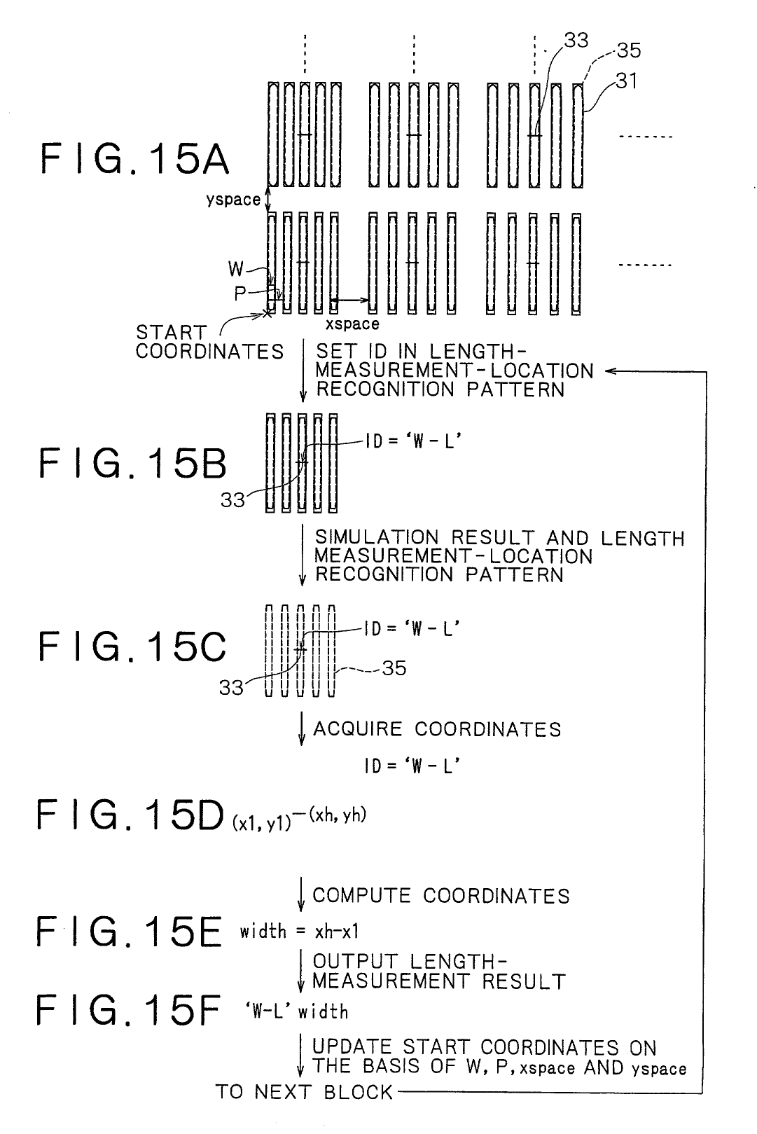

The simulation ST302 produces data of a transfer pattern as a result of the simulation. FIG. 15A is a diagram showing the design pattern 31, the length-measurement-location recognition pattern 33 added to the design pattern 31 and the transfer pattern 35 produced by the simulation. The transfer pattern 35 is produced at a shift relative to the shape of design shape 31.

ST303

After the simulation result DT303 described above is obtained, a line width is automatically measured on the basis of the simulation result DT303.

In the automatic measurement of a line width, first of all, for the length-measurement-location recognition pattern 33 added to a block placed at the edge, a recognition symbol ID=‘W−L’ is set as shown in FIG. 15B.

Then, the length-measurement-location recognition pattern 33 and the transfer pattern 35 are identified as shown in FIG. 15C. Subsequently, as shown in FIG. 15D, the coordinates of a portion at which the edges of both the length-measurement-location recognition pattern 33 and the transfer pattern 35 intersect each other are acquired. Then, as shown in FIG. 15E, the line width of the transfer pattern is computed from the coordinates. To put in detail, the width of a length-measurement location is computed in accordance with an equation width=xh=xl. Finally, as shown in FIG. 15F, the line width is output by associating the line width with a recognition symbol ID. Thereafter, the same processing is repeated for each of the remaining blocks to compute a line width for the transfer pattern 35 of each block.

ST304

A table of line-width-measurement results like Table 1 shown below is created on the basis of line-width-measurement results obtained as described above. The table of line-width-measurement results associates each line width measured for a transfer pattern with the line width W of each line-like pattern and the pitch P of line-like patterns in the design pattern. It should be noted that the table of line-width-measurement results shows measured line widths for the design pattern's width W and pitch P, which are given as follows:

W(microns)=0.12+0.01×n(where n=0, 1, 2 and so on)

P(microns)=0.42+0.01×n(where n=0, 1, 2 and so on)

TABLE 1

| W P | 0.420 | 0.430 | 0.440 | 0.450 | 0.460 | 0.470 | 0.480 |
|---|---|---|---|---|---|---|---|
| 0.120 | 0.108 | 0.104 | 0.102 | 0.100 | 0.096 | 0.092 | 0.088 |
| 0.130 | 0.126 | 0.124 | 0.124 | 0.122 | 0.120 | 0.118 | 0.116 |
| 0.140 | 0.142 | 0.142 | 0.142 | 0.138 | 0.138 | 0.136 | 0.134 |
| 0.150 | 0.154 | 0.154 | 0.154 | 0.152 | 0.152 | 0.152 | 0.152 |
| 0.160 | 0.166 | 0.164 | 0.164 | 0.164 | 0.164 | 0.164 | 0.162 |
| 0.170 | 0.176 | 0.174 | 0.174 | 0.174 | 0.174 | 0.174 | 0.174 |
| 0.180 | 0.186 | 0.184 | 0.184 | 0.184 | 0.182 | 0.182 | 0.182 |
| 0.190 | 0.198 | 0.194 | 0.194 | 0.192 | 0.194 | 0.192 | 0.192 |
| 0.200 | 0.210 | 0.206 | 0.204 | 0.202 | 0.202 | 0.202 | 0.202 |

ST305

Then, the result of the simulation is studied. The study is conducted to form a judgment as to whether or not a target pattern is within the range of required specifications PA304 set for a target line width. The target pattern is the line-like pattern designed on the basis of the line width W and the pitch P, which each serve as a target. For example, assume that the target pattern is a line-like pattern designed on the basis of a line width W of 0.13 microns and a pitch P of 0.42 microns. In this case, a measured line width of 0.126 microns for a transfer pattern of the target pattern is compared with a required specification of 0.13±0.01 microns. A plurality of target patterns is set, and required specifications are provided for each of the target patterns.

ST306

If the line widths of the transfer patterns for the target patterns are within the ranges of their respective required specifications, the result of the simulation is determined to be optimum. In this case, the flow of the processing goes on in the YES direction. If the line widths of the transfer patterns for the target patterns are not within the ranges of their respective required specifications, on the other hand, the result of the simulation is determined to be not optimum. In this case, the flow of the processing goes on in the NO direction.

ST307

If the flow of the processing goes on in the YES direction, a rule-base OPC correction table is formed on the basis of the created line-width-measurement-result table ST304. In the creation of such a table, assume that it is necessary to find a correction value for implementing a line width of 0.13 microns in the transfer pattern. In this case, for a pitch P of 0.42 microns, the transfer pattern's line width of 0.126 microns is closest to 0.13 microns. Thus, a correction value of 0.000 microns (=0.130−0.130)/2 is applied to the line width's design value of 0.130 microns. By the same token, when it is necessary to find a correction value for implementing a line width of 0.13 microns in the transfer pattern, for a pitch P of 0.46 microns, the transfer pattern's line width of 0.138 microns is closest to 0.13 microns. Thus, a correction value of 0.005 microns (=0.140−0.130)/2 is applied to the line width's design value of 0.140 microns. As described above, the rule-base OPC correction table is created by finding a correction value for implementing each line width for each pitch.

ST308

If the flow of the processing goes on in the NO direction, on the other hand, a simulation parameter is corrected. The corrected simulation parameter is a simulation parameter applied to the preceding simulation execution ST302. To be more specific, the corrected simulation parameter is the initial simulation parameter PA302.

ST302

Then, a second simulation is carried out by applying the corrected simulation parameter. Thereafter, the processes described above are carried out repeatedly until the outcome of the judgment formed in the processing ST306 is YES indicating that the result of the simulation is optimum. Thus, a rule-base OPC correction table is created by simulation based on an optimum simulation parameter.

Then, on the basis of the created rule-base OPC correction table PA305, optical proximity correction is applied to design data of typically a gate wire and, then, a lithography process using an exposure mask obtained as a result of the optical proximity correction is carried out to form an actual pattern (or a transfer pattern) based on the design data.

In the case of the third embodiment described above, in the processing ST301, a length-measurement-location recognition pattern based on a parameter set in advance is added to a design pattern for a test pattern for creating a rule-base OPC correction table. Thus, a line width at each line-width-measurement location in a transfer pattern obtained as a result of the simulation is automatically measured on the basis of position information of a length-measurement-location recognition pattern so that the amount of labor required for the measurement of line widths can be reduced considerably. As a result, the rule-base OPC correction table showing measured line widths at all length-measurement locations can be created with ease and the precision of the correction table can be improved.

It should be noted that, in the case of the third embodiment, in creation of a rule-base OPC correction table, simulation is carried out repeatedly by using a corrected simulation parameter for optimizing the simulation parameter. If a process condition has been established, however, a first simulation can also be carried out by using the established process condition as a simulation parameter to create a correction table. Even in such a case, a rule-base OPC correction table showing measured line widths at all length-measurement locations can be created with ease and the precision of the correction table can be improved.

While preferred embodiments of the present invention have been described using specific terms, such description is for illustrative purposes only, and it is to be understood that changes and variations may be made without departing from the spirit or scope of the following claims.

What is claimed is:

1. A pattern-creating method for creating a transfer pattern of a design pattern by carrying out a lithography process comprising:
a first step of identifying line-width-measurement locations in a design pattern on the basis of a condition determined in advance, and adding a length-measurement-location recognition pattern at each of said line-width-measurement locations;
a second step of carrying out simulation of transfer-pattern creation on the basis of said design pattern;
a third step of measuring a line width of a transfer pattern obtained from said simulation at the position of each of said length-measurement-location recognition patterns; and
a fourth step of evaluating a result of said simulation on the basis of line widths of transfer patterns measured in said third step.

2. A pattern-creating method according to claim 1, wherein, in said fourth step, a difference between a line width of said design pattern and said line width of said transfer pattern at each of said line-width length-measurement locations is examined to form a judgment as to whether or not said difference is within an allowable range set in advance and, if an outcome of said judgment indicates that said difference is not within said allowable range, a process condition for said transfer-pattern creation is changed and a flow of processing based on said pattern-creating method goes back to said second step.

3. A pattern-creating method according to claim 1, wherein, in said fourth step, a difference between a line width of said design pattern and said line width of said transfer pattern at each of said line-width length-measurement locations is examined to form a judgment as to whether or not said difference is within an allowable range set in advance and, if an outcome of said judgment indicates that said difference is not within said allowable range, the shape of an exposure pattern used in said lithography process in said transfer-pattern creation is changed and a flow of processing based on said pattern-creating method goes back to said second step.

4. A pattern-creating method for creating a transfer pattern of a design pattern by carrying out a lithography process comprising:
a first step of classifying pattern portions composing said design pattern by degree of importance with which the shape of said design pattern is to be maintained;
a second step of carrying out simulation of transfer-pattern creation on the basis of said design pattern; and
a third step of evaluating a result of said simulation for each of said degrees of importance, which are associated with said respective pattern portions composing said design pattern, and for each portion of said transfer pattern.

5. A pattern-creating method according to claim 4, wherein said evaluation of said result of said simulation for each of said portions of said transfer pattern in said third step is based on at least one of a difference between a line width of said design pattern and a line width of said transfer pattern, and an edge error quantity of said transfer pattern relative to an edge of said design pattern.

6. A pattern-creating method according to claim 4, wherein, in said third step, a predetermined evaluation value is measured for each of said portions of said transfer pattern and a result of measuring said evaluation value is examined to form a judgment as to whether or not said result is within an allowable range set in advance for each of said degrees of importance and, if an outcome of said judgment indicates that said result is not within said allowable range, a process condition for said transfer-pattern creation is changed and a flow of processing based on said pattern-creating method goes back to said second step.

7. A pattern-creating method according to claim 4, wherein, in said third step, a predetermined evaluation value is measured for each of said portions of said transfer pattern and a result of measuring said evaluation value is examined to form a judgment as to whether or not said result is within an allowable range set in advance for each of said degrees of importance and, if an outcome of said judgment indicates that said result is not within said allowable range, the shape of an exposure pattern used in said lithography process in said transfer-pattern creation is changed and a flow of processing based on said pattern-creating method goes back to said second step.

8. A pattern-creating method according to claim 4, said pattern-creating method further comprising:
an adding step carried out prior to said second step to identify line-width-measurement locations on said design pattern on the basis of a condition determined in advance, and to add a length-measurement-location recognition pattern at each of said identified line-width-measurement locations; and
a measuring step carried out between said second and third steps to measure a line width of said transfer pattern at each of said length-measurement-location recognition patterns,
wherein, in said third step, a line width of said transfer pattern is evaluated for each of said degrees of importance.

9. A pattern-creating method according to claim 8, wherein, in said third step, for each of portions composing said transfer pattern, a difference between a line width of said design pattern and a line width of said transfer pattern as well as an edge error quantity of said transfer pattern relative to an edge of said design pattern are evaluated.

10. A pattern-creating method according to claim 8, wherein, in said third step, a difference between a line width of said design pattern and a line width of said transfer pattern at each of said length-measurement-location recognition patterns is examined to form a judgment as to whether or not said difference is within an allowable range set in advance for each of said degrees of importance and, if an outcome of said judgment indicates that said difference is not within said allowable range, a process condition for said transfer-pattern creation is changed and a flow of processing based on said pattern-creating method goes back to said second step.

11. A pattern-creating method according to claim 8, wherein, in said third step, a difference between a line width of said design pattern and a line width of said transfer pattern at each of said length-measurement-location recognition patterns is examined to form a judgment as to whether or not said difference is within an allowable range set in advance for each of said degrees of importance and, if an outcome of said judgment indicates that said difference is not within said allowable range, the shape of an exposure pattern used in said lithography process in said transfer-pattern creation is changed and a flow of processing based on said pattern-creating method goes back to said second step.

12. A pattern-processing apparatus used in creation of a transfer pattern of a design pattern by carrying out a lithography process comprising:
a length-measurement-location-adding unit for identifying line-width-measurement locations in a design pattern on the basis of a condition determined in advance, and adding a length-measurement-location recognition pattern at each of said line-width-measurement locations;
a simulation unit for carrying out simulation of transfer-pattern creation on the basis of said design pattern;
a line-width-measuring unit for measuring a line width of a transfer pattern obtained from said simulation carried out by said simulation unit at the position of each of said length-measurement-location recognition patterns; and
an evaluation unit for evaluating a result of said simulation on the basis of line widths of transfer patterns measured by said line-width-measuring unit.

13. A pattern-processing apparatus for creating a transfer pattern of a design pattern by carrying out a lithography process comprising:
a weight-classifying unit for classifying pattern portions composing said design pattern by degree of importance with which the shape of said design pattern is to be maintained;
a simulation unit for carrying out simulation of transfer-pattern creation on the basis of said design pattern; and
an evaluation unit for evaluating a result of said simulation for each of said degrees of importance, which are associated by said weight-classifying unit with said respective pattern portions composing said design pattern, and for each portion of said transfer pattern obtained from said simulation carried out by said simulation unit.

14. An exposure mask used in creation of a transfer pattern of a design pattern by carrying out a lithography process, wherein each exposure pattern portion corresponding to one of parts composing said design pattern provides a peculiar shape margin to a degree of importance with which the shape of said design pattern is to be maintained.
